(19) United States
(12) Patent Application Publication
(10) Pub. No.: US 2023/0038689 A1
(43) Pub. Date: Feb. 9, 2023

(54) SYSTEMS AND METHODS FOR PROVIDING USER GUIDANCE VIA A WORKSPACE SCORE

(71) Applicant: Citrix Systems, Inc., Fort Lauderdale, FL (US)

(72) Inventors: Zongpeng Qiao, Nanjing (CN); Shutian Yao, Nanjing (CN); Ke Xu, Nanjing (CN); Jie Zhuang, Nanjing (CN)

(73) Assignee: Citrix Systems, Inc., Fort Lauderdale, FL (US)

(21) Appl. No.: 17/408,200

(22) Filed: Aug. 20, 2021

Related U.S. Application Data
(63) Continuation of application No. PCT/CN2021/110182, filed on Aug. 3, 2021.

(51) Int. Cl. G06Q 10/06

(52) U.S. Cl. CPC G06Q 10/06393; G06Q 10/06398

(57) ABSTRACT

Described embodiments provide systems, methods, non-transitory computer-readable medium for generating a workspace score. The workspace score may be used to help a user make better use of applications on a remote workspace. The workspace score may be based on factors of user behavior. These factors may include such things as the immersion dimension, mature dimension, vendor preference dimension, discovery dimension, and others. These factors may monitor such things as the amount of features used in the remote workspace compared with the available features, the amount of applications used on a remote desktop workspace when compared with the amount of applications used on the local client device, and the amount of applications used by a preferred vendor, among others.

### CROSS-REFERENCE TO RELATED APPLICATION

This application is a continuation of and claims priority to and the benefit of International Patent Application No. PCT/CN2021/110182, titled “SYSTEMS AND METHODS FOR PROVIDING USER GUIDANCE VIA A WORKPLACE SCORE,” and filed on Aug. 3, 2021, the contents of all of which are hereby incorporated herein by reference in its entirety for all purposes.

### FIELD OF THE DISCLOSURE

The present application generally relates to workspaces for accessing local and remote application, including but not limited to systems and methods of calculating a workspace score based on usage of local and remote applications.

### BACKGROUND

Applications can be used either locally, such as on a client computing device, or remotely, such as on a remote server or cloud. With the proliferation of applications accessible locally and remotely via a client computing device, it becomes challenging for users to determine which applications are best suited to use and from which location.

### BRIEF SUMMARY

Remote desktops allow users to access documents and applications across a variety of client devices. Additionally, such desktops may have more security than client devices, protecting the documents and applications confidentiality and from corruption. Additionally, it is easier to promote process uniformity and ensure backup and loss protection for work performed on a properly managed cloud. Additionally, work done in a remote mode may give the organization useful information, such as which applications are most heavily relied on and which additional applications may be useful. Such information may be used to help an employee transition to applications which may be more beneficial for particular purposes or to help an organization determine which applications to license or prioritize. For these reasons, it can be beneficial to help users transition from using applications in a local mode to working on a remote desktop.

Gamification has been shown to be helpful in organizational change management. In gamification, traditional elements of games are brought in to help a user adopt a change. Such elements include points systems and challenges to help an organization engage its employees in a beneficial change.

Disclosed herein is a system to help employees make better use of a remote workspace, for instance, by increasing the use of applications in the remote workspace over local applications or by increasing the number of applications used. One or more aspects of this disclosure are directed to systems, methods, devices, non-transitory computer-readable medium for determining a workspace score for a user.

In some embodiments, a method may include identifying, by a score agent, a plurality of applications that are provided both in a local environment of a device and within a workspace accessible via the device. The method may include determining, by the score agent, which one or more of the plurality of applications are used by a user of the device via the workspace instead of the local environment of the device. The method may include causing, by the score agent responsive to the determination, generation of a score for the user, the score identifying a degree of which the user makes use of the workspace. The method may include providing, by the score agent, the score for display in the workspace.

In some embodiments, the method may include monitoring, by the score agent, which one or more applications in the local environment the device are opened by the user. The method may include determining, by the score agent, a number of features the user accessed in the workspace in comparison to a predetermined number of features provided by the workspace. The score may be generated based at least on this number of features. The method may include determining, by the score agent, a number of applications the user accessed in the workspace in comparison to a predetermined number of applications provided by the workspace. The score may be generated based at least on this number of applications. The method may include determining, by the score agent, a number of applications of a specific vendor the user accessed in the workspace in comparison to a total number of applications provided by the specific vendor in the workspace. The score may be generated based at least on this number of applications.

Disclosed herein is a system comprising one or more processors, coupled to memory. The system may identify a plurality of applications that are provided both in a local environment of a device and within a workspace accessible via the device. The system may determine which one or more of the plurality of applications are used by a user of the device via the workspace instead of the local environment of the device. The system may cause generation of a score for the user, responsive to the determination, the score identifying a degree of which the user makes use of the workspace. The system may provide the score for display in the workspace.

In some embodiments, the one or more processors may be further configured to monitor which one or more applications in the local environment the device are opened by the user. The one or more processors may be configured to determine a number of features the user accessed in the workspace in comparison to a predetermined number of features provided by the workspace. The score may be generated based at least on the number of features. In some embodiments, the one or more processors may be further configured to determine a number of applications the user accessed in the workspace in comparison to a predetermined number of applications provided by the workspace. The score may be generated based at least on the number of applications. In some embodiments, the one or more processors may be further configured to determine a number of applications of a specific vendor the user accessed in the workspace in comparison to a total number of applications provided by the specific vendor in the workspace. The score may be generated based at least on the number of applications.

Disclosed herein is a non-transitory computer readable medium storing program instructions for causing one or more processors to identify a plurality of applications that are provided both in a local environment of a device and within a workspace accessible via the device. The instructions may cause the one or more processors to determine which one or more of the plurality of applications are used by a user of the device via the workspace instead of the local environment of the device. The instructions may cause the one or more processors to cause generation of a score for the user, responsive to the determination, the score identifying a degree of which the user makes use of the workspace. The instructions may cause the one or more processors to provide the score for display in the workspace.

In some embodiments, the program instructions may further cause the one or more processors to monitor which one or more applications in the local environment the device are opened by the user. The program instructions may cause the one or more processors to determine a number of features the user accessed in the workspace in comparison to a predetermined number of features provided by the workspace. The score may be generated based at least on the number of features.

These and other aspects and implementations are discussed in detail below. The foregoing information and the following detailed description include illustrative examples of various aspects and implementations, and provide an overview or framework for understanding the nature and character of the claimed aspects and implementations.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device.

FIG. 1B is a block diagram depicting a computing environment comprising client device in communication with cloud service providers.

FIG. 2A is a block diagram of an example system in which resource management services may manage and streamline access by clients to resource feeds (via one or more gateway services) and/or software-as-a-service (SaaS) applications.

FIG. 2B is a block diagram showing an example implementation of the system shown in FIG. 2A in which various resource management services as well as a gateway service are located within a cloud computing environment.

FIG. 3 is a block diagram showing an example implementation in which several different services are included among the resource management services.

FIG. 4A is a block diagram of an example implementation of a workspace scoring system.

FIG. 4B shows the graphical user interface including a workspace score icon, according to one embodiment.

FIG. 4C shows an example view of the graphical user interface including the workspace score icon and a workspace score.

FIG. 4D shows an example view of the graphical user interface including a drop down menu providing access to the workspace score.

FIG. 4E shows an example view of the graphical user interface including dimension details used to calculate the workspace score.

FIG. 4F shows an example view of the graphical user interface including a drill down of the Immersion Dimension and applications used in the workspace.

FIG. 5A is a block diagram of one embodiment of a method of generating and displaying a workspace score.

FIG. 5B is a block diagram of one embodiment of a method of generating and displaying a workspace score.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein;

Section B describes resource management services for managing and streamlining access by clients to resource feeds; and

Section C describes systems and methods of generating and displaying a workspace score.

### A. Computing Environment

Prior to discussing the specifics of embodiments of the systems and methods of an appliance and/or client, it may be helpful to discuss the computing environments in which such embodiments may be deployed.

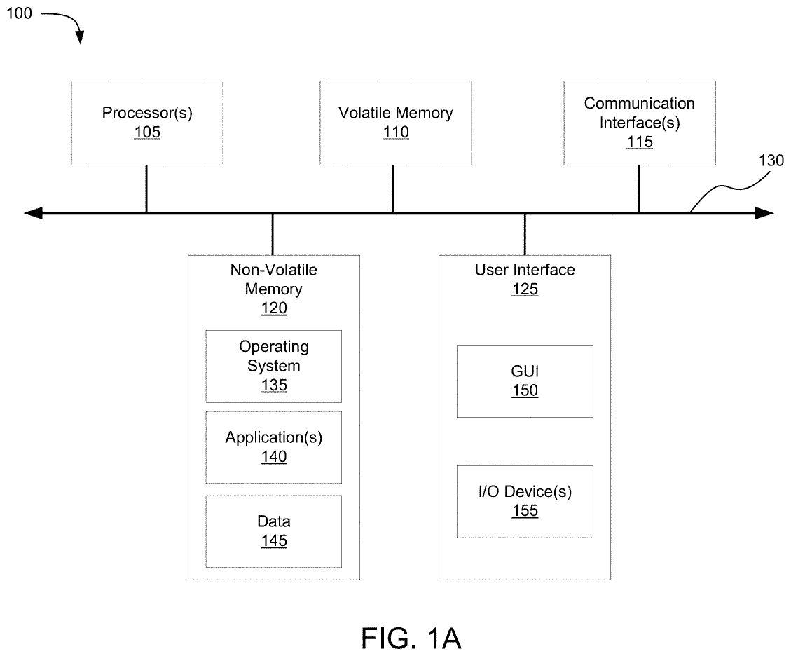

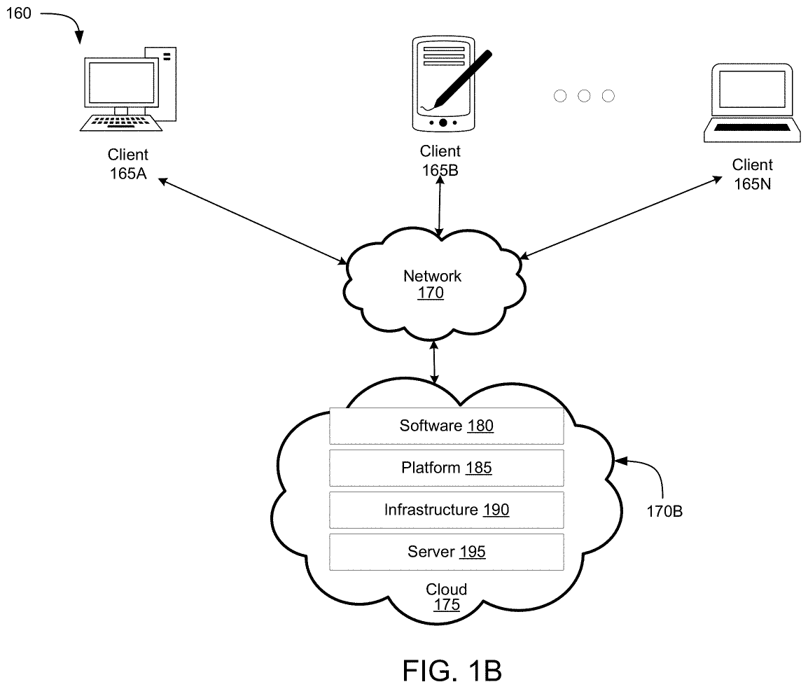

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 108 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

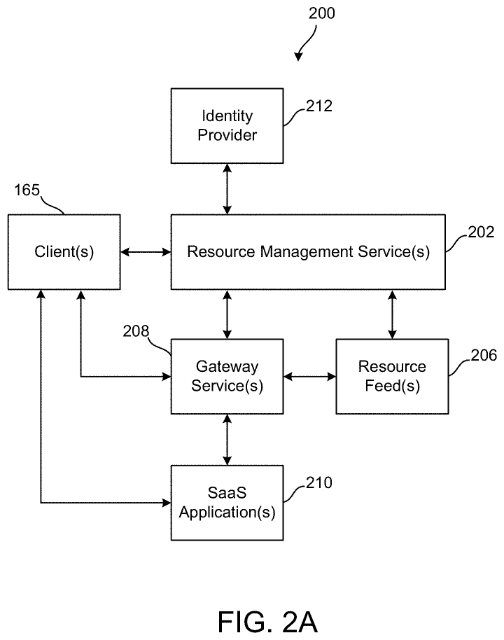

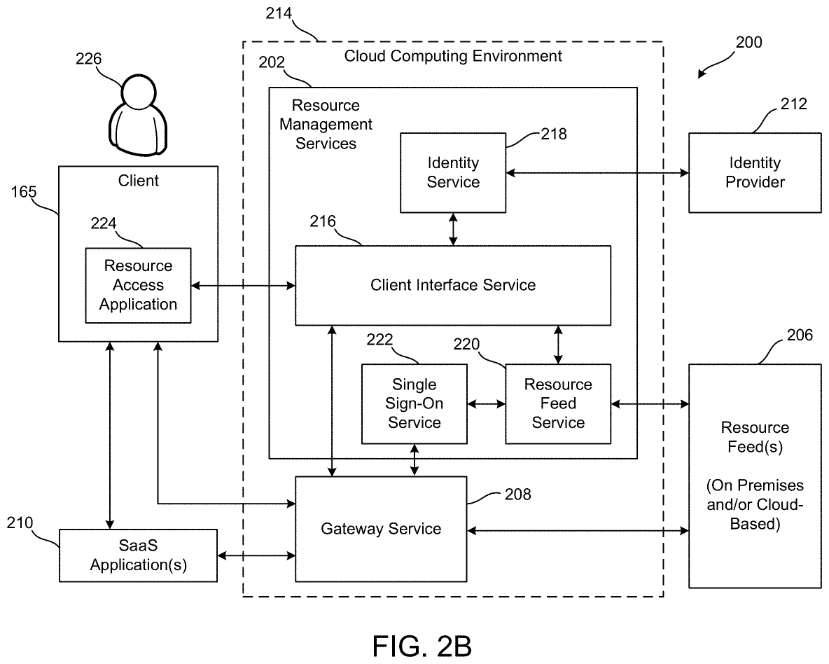

FIG. 2A is a block diagram of an example system 200 in which one or more resource management services 202 may manage and streamline access by one or more clients 165 to one or more resource feeds 206 (via one or more gateway services 208) and/or one or more software-as-a-service (SaaS) applications 210. In particular, the resource management service(s) 202 may employ an identity provider 212 to authenticate the identity of a user of a client 165 and, following authentication, identify one of more resources the user is authorized to access. In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 165 may be any type of computing devices capable of accessing the resource feed(s) 206 and/or the SaaS application(s) 210, and may, for example, include a variety of desktop or laptop computers, smartphones, tablets, etc. The resource feed(s) 206 may include any of numerous resource types and may be provided from any of numerous locations. In some embodiments, for example, the resource feed(s) 206 may include one or more systems or services for providing virtual applications and/or desktops to the client(s) 165, one or more file repositories and/or file sharing systems, one or more secure browser services, one or more access control services for the SaaS applications 210, one or more management services for local applications on the client(s) 165, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud computing environment may, for example, include Microsoft Azure Cloud, Amazon Web Services, Google Cloud, or IBM Cloud.

For any of illustrated components (other than the client 165) that are not based within the cloud computing environment 214, cloud connectors (not shown in FIG. 2B) may be used to interface those components with the cloud computing environment 214. Such cloud connectors may, for example, run on Windows Server instances hosted in resource locations and may create a reverse proxy to route traffic between the site(s) and the cloud computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 224 is launched or otherwise accessed by the user 226, the client interface service 216 may send a sign-on request to the identity service 218. In some embodiments, the identity provider 212 may be located on the premises of the organization for which the system 200 is deployed. The identity provider 212 may, for example, correspond to an on-premises Windows Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a Microsoft Azure Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For each configured resource feed, the resource feed service 220 may request an identity token from the single sign-on service 222. The resource feed service 220 may then pass the feed-specific identity tokens it receives to the points of authentication for the respective resource feeds 206. Each resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more interne enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource application 224 is located remotely), e.g., via a secure browser service. In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 165 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may be pushed to clients 165 to notify a user 226 of something that requires the user's attention (e.g., approval of an expense report, new course available for registration, etc.).

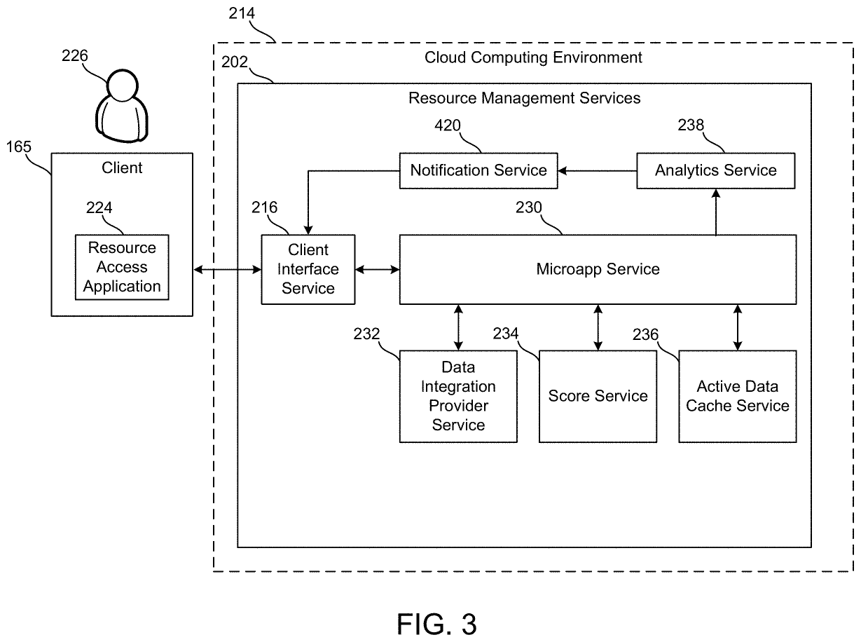

FIG. 3 is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 3 may enable the provision of a streamlined resource activity feed and/or notification process for a client 165. In the example shown, in addition to the client interface service 216 discussed above, the illustrated services include a microapp service 230, a data integration provider service 232, a score service 234, an active data cache service 236, an analytics service 238, and a notification service 240. In various embodiments, the services shown in FIG. 3 may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 3 may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 3, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the score service 234 may generate a score for the user.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

In some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the score service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the score service 234 an encrypted Oauth2 token for the system of record for which the action is to be invoked, and may send the action to the data integration provider service 232 together with the encrypted Oath2 token. The data integration provider service 232 may then decrypt the Oath2 token and write the action to the appropriate system of record under the identity of the user 226. The data integration provider service 232 may then read back changed data from the written-to system of record and send that changed data to the microapp service 230. The microapp service 232 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back-end. In some embodiments, users may be able to interact with the virtual assistance through either the resource access application 224 or directly from another resource, such as Microsoft Teams. This feature may allow employees to work efficiently, stay organized, and deliver only the specific information they are looking for.

### C. Systems and Methods of a Workspace Scoring System

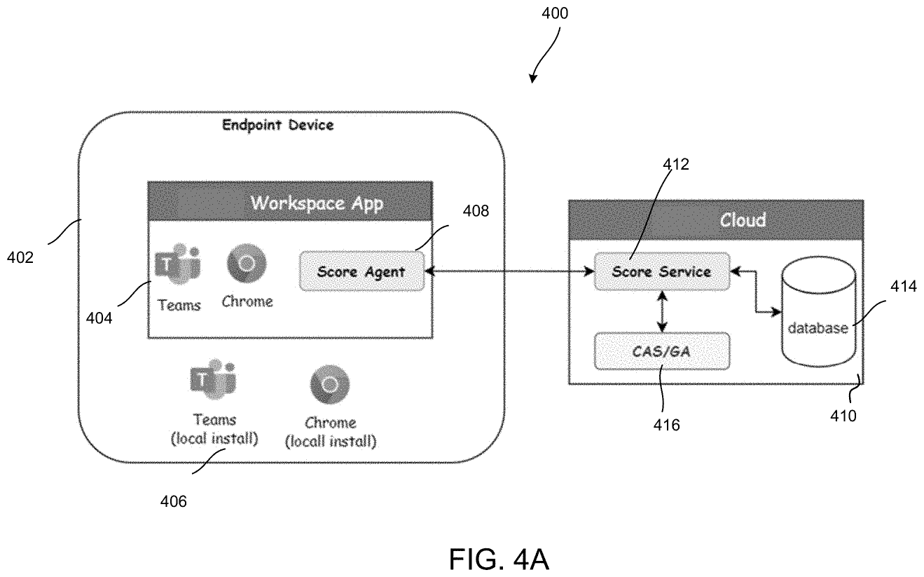

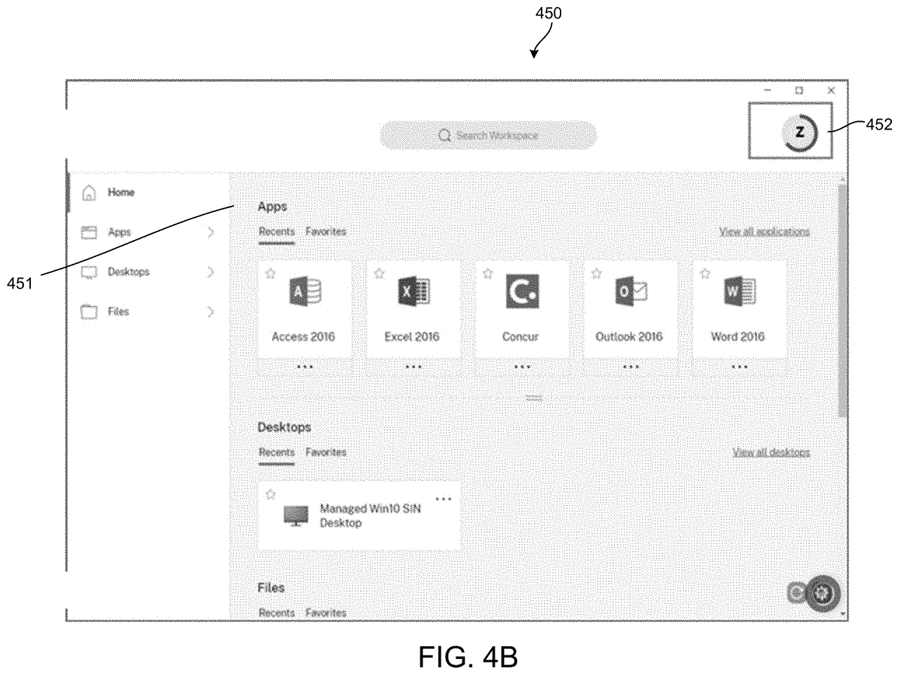

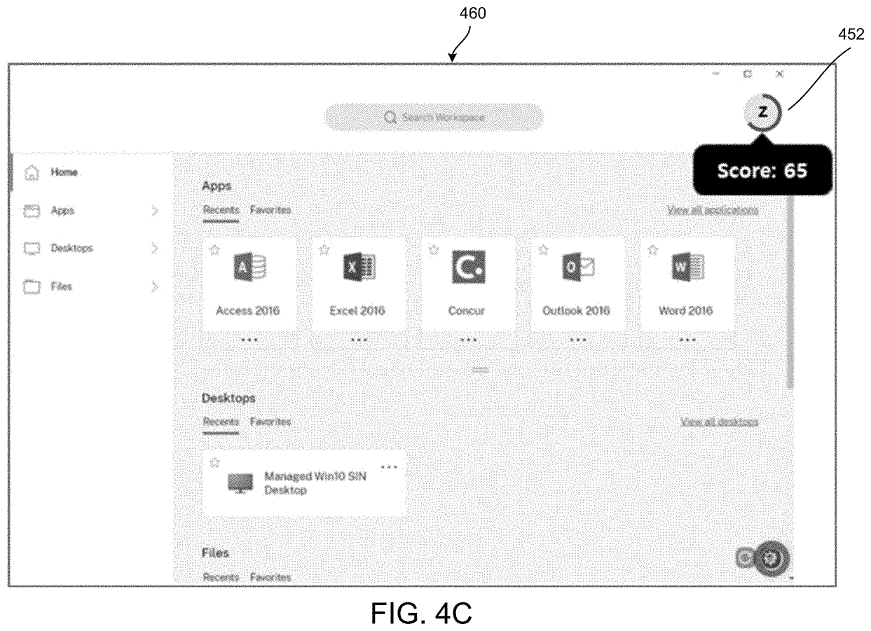

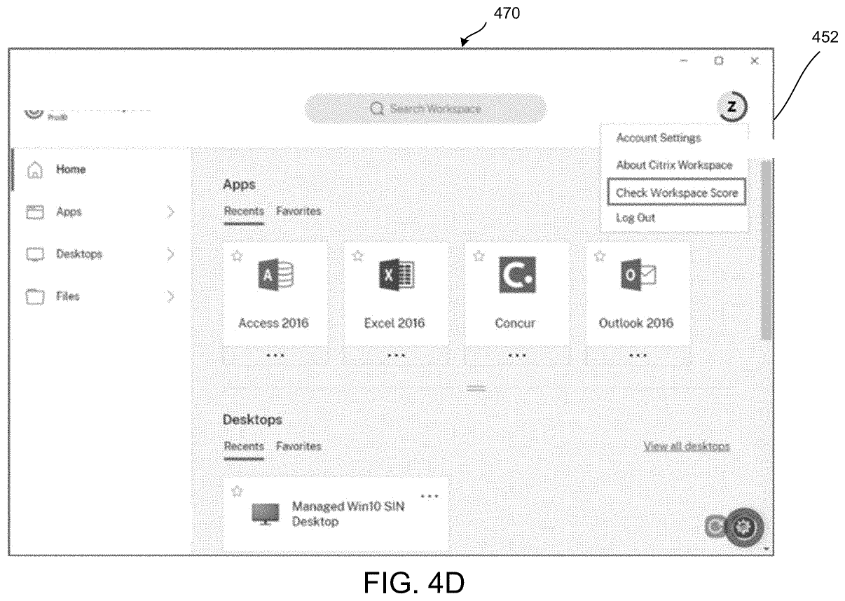

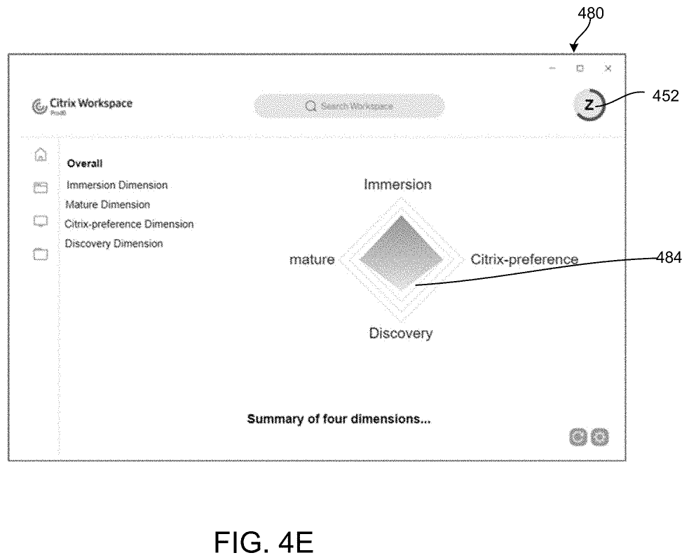

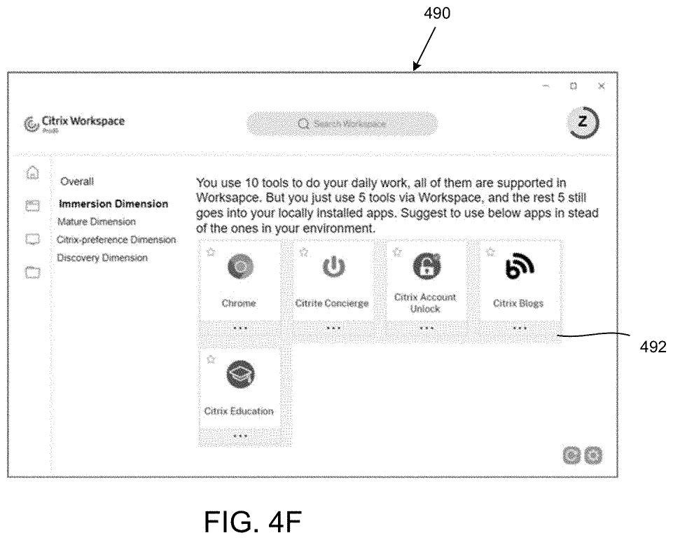

FIG. 4A is a block diagram of an example implementation of a workspace scoring system 400. In brief overview, a workspace app 404 operates on an endpoint device 402. The workspace app 404 provides access to local applications 406. The workspace app may also provide access to and identify versions or present of remote applications corresponding to the local application in a cloud environment 410, such as a workspace hosted on one or more remote servers. The workspace scoring system 400 may include a score agent 408 running on the endpoint device 402 or as part of the workspace app 404. The score agent 408 may communicate over a network to a score service 412 operating in the cloud environment 410. The score service 412 may interface with a database 414 that stores data associated with or used for generating a workspace score. The score service 412 may interface or communicate with a central authentican service (CAS)/general availability (GA) service 416. The CAS/GA service 416 which is used to collect, store and provide customer improvement experience data (CEIP). The score agent 408, the score service 412 and/or the CAS/GA service 416 are use to collect and process data to generate and provide a workspace score for a user as further described herein.

The workspace scoring system 400 operates on and accessed via an endpoint device 402 in communication with a workspace and/or score service in a cloud environment or remote servers. The endpoint device 402 may be any type and form of client device 165. The endpoint device 402 may be a local computer processor system. The endpoint device 402 may be a server or set of processors acting together as a unit. The endpoint device 402 may be used by a specific user. The endpoint device 402 may be used by different users. The workspace system may be deployed, installed or executed on the end point device as the workspace app 404 with a score agent 408.

The workspace app and/or score agent may determine the presence, installation or availability of local applications 406. The local applications 406 may be downloaded and run directly from the endpoint device 402. The local applications 406 may be run on a single processor or on multiple processors of the endpoint device. The workspace app and/or score agent may determine the presence of the same applications in a cloud environment, remote server, hosted or provided by a remote service, such as a hosted application or desktop. The workspace app and/or score agent may determine which one or more of the local applications 406 are used by the user and/or accessed via the endpoint device. The workspace app and/or score agent may determine which one or more of the remote versions of the local applications, such as available in the workspace, are used by the user and/or accessed via the endpoint device.

The workspace scoring system may operate or integrate with or include a workspace app 404. The workspace app 404 may be an application that allows other applications to run on a remote desktop. The workspace app 404 may be run on the remote desktop or run on the endpoint device 402. The workspace app 404 may run additional applications within the workspace application. In some implementations, the workspace app 404 may direct use of other applications on the remote desktop. The workspace app 404 may be any embodiments of resource application 224 described in conjunction with FIGS. 2A-3.

The score or scoreing agent 408 may be any type of form of executable instructions, including a task, service, library, program, script, application. The score agent 408 may run on the remote desktop or on the endpoint device 402. The score agent 408 may be part of the workspace app 404. In some implementations, the score agent may be a separate application interfaced with or in communications with the workspace app 404. The score agent 408 may be designed, constructed and configured to collect data to provide to the score service to generate a workspace score. The score agent 408 may be designed, constructed and configured to obtain, generate, calculate, display or provide the workspace score and/or data and information for the same. In some implementations, the score agent 408 may receive or request the workspace score from the score service 412.

The score agent 408 may provide a number of functionalities. In some embodiments, the score agent may monitor the user's operation within the endpoint device 402 and/or the remote desktop. The score agent may monitor user's usage of local applications and/or remote applications. The score agent may monitor timing and frequency of access to, launching or opening of the local applications and/or remote applications. The score agent may identify which local applications and/or remote application the users does not use or does not use on a certain basis or frequency. The score agent may monitor user's usage of remote application versus corresponding local application. The score agent may monitor user's usage of a local application versus corresponding remote application. Usage may include the time the local and/or remote application has been used, for how long, how frequent, what days and time frames, what other applications being used, etc. The score agent 408 may monitor activities for relevant factors, such as dimensions, of user activity, including but not limited to the following one or more dimensions: the immersion dimension, the mature dimension, the vendor-preference dimension, and the discovery dimension.

The score agent may track and/or record this data. In some embodiments, the score agent may cause the data to be saved in a database for retrieval and comparative analysis. The score agent may track or record this data via the score service such as into the database. The score agent may communicate or send this data to the score service such as in real-time or a certain frequency or based on certain events.

The score agent 408 may receive workspace score values or calculation from the score service. The score agent 408 may provide the workspace score for display on the endpoint device. The score agent 408 may display the workspace score in a user interface of the workspace app. The score agent 408 may display the workspace score in a user interface of the workspace app responsive to a user's interaction with the workspace app and/or a local application. The score agent 408 may update the workspace score in the user interface in real-time, on a frequency, responsive to an event or responsive to a user interface interaction with the user interface. The score agent 408 may update the workspace score responsive to receiving an update from the score service 412.

The score service 412 may be any type of form of executable instructions, including a task, service, library, program, script, application, etc. The score service 412 may operate as part of the workspace on a remote server, such as in cloud environment. The score service 412 may run on any one or more servers accessible by the score agent. The score service 412, or portions thereof may run on endpoint device. The score service 412 may be distributed between one or more endpoint devices and one or more servers. The score service 412 may interface and/or communicate with the score agent, such as via any type of programming interface or protocol.

In one embodiment, the score service 412 may calculate the workspace score by taking into account the following one or more dimensions: the immersion dimension, the mature dimension, the vendor-preference dimension, and the discovery dimension. Those skilled in the art will recognize that these are not the only dimensions that may be used, but serve as an example of some of the sorts of dimensions that may be considered in determining a workspace score. In one embodiment, the score agent 408 may calculate the workspace score by taking into account the following one or more dimensions: the immersion dimension, the mature dimension, the vendor-preference dimension, and the discovery dimension. Those skilled in the art will recognize that these are not the only dimensions that may be used, but serve as an example of some of the sorts of dimensions that may be considered in determining a workspace score. The score agent and/or score service may use data collected from the score agent and/or data stored in the database and/or data from the CAG/GA service to determine, calculate or generate the workspace score, such as for any of the dimensions described in connection with FIG. 4E.

The workspace score may be based on or calculated using an immersion dimension. The immersion dimension may denote the degree the user leverages applications in the workspace remote environment in comparison with the degree the user leverages applications in the local environment. The workspace score may be based on or calculated using a mature dimension. The mature dimension may denote how many features have been used by the user when compared with all features supported by workspace. The workspace score may be based on or calculated using a vendor-preference dimension. The vendor-preference dimension may denote what fraction of the tools the user is utilizing from a preferred vendor. The workspace score may be based on or calculated using a discovery dimension. The discovery dimension may denote how many applications have been used by the user compared with all the applications provided in workspace. The workspace score may be based on or calculated using any combination with any weighting of one or more of the immersion dimension, mature dimension, vendor-preference dimension and discovery dimension.

For the immersion dimension, the score agent 409 may monitor the applications opened by the user. The score agent 409 may determine which applications are provided on both the endpoint device 402 and the workspace or remote desktop. In some embodiments, the data may be collected by the score agent 409 by analyzing user information, such as by analyzing Windows Customer Experience Improvement Program (CEIP) data.

For the vendor-preference dimension, the score agent may monitor the vendor-owned applications. In some embodiments, the vendor-owned applications utilized remotely are monitored. In some embodiments, the vendor-owned applications utilized locally are monitored. In other embodiments, the remotely accessed vendor-owned applications are monitored in workspace and the locally accessed vendor-owned applications are monitored by analyzing user information, such as the CEIP data.

In some embodiments, the score agent 409 collects user data for the score service to 412 calculate the workspace score. In these embodiments, the data collected by the score agent 409 may be sent to the score service 412 for calculation. In other embodiments, the score agent 409 itself may calculate the workspace score. In some embodiments, the score agent 409 sends a request to the score service 412 to calculate the workspace score. The score agent 409 may wait for the score service 412 to return the workspace score and then update the workspace score on the graphical user interface.

The score service 412 may provide one or more of the following functions. The score service may query or access CEIP data, such as from the Central Authentication Service (CAS) 416 to collect user data, for one or more dimensions. In some embodiments, the score service 412 waits for data or received data collected from the score agent for one or more dimensions. For example, the score service may collect the data for the mature dimension while the score agent collects the data from the remaining dimension and forwards it to the score service. The score service 412 may calculate the workspace score upon request, or at a specified interval (for instance, once a day). The score service 412 may generate a summary based on the workspace score and send the summary to the score agent 409.

In some embodiments, the score service 412 may be run remotely, such as on the cloud 410, which may be a cloud 175 or computing environment 160. In some embodiments, the cloud 410 may include a database 414. The score service 412 may access the database 414 to store one or more of raw data, historical workspace scores, dimensions used for calculations, endpoint device data, or other information related to the workspace score. The score service 412 may utilize the data stored in the database 414 to determine user trends, perform comparative analysis, and update, improve or optimize the algorithms used to determine the workspace score.

FIG. 4B shows the graphical user interface including a workspace score icon, according to one embodiment. For example, the workspace score icon may be shown as a double circle around the user's name icon. The outer circle may be filled in to indicate the workspace score. For instance, in FIG. 4B, 65% of the outer circle is filled in blue, indicating a workspace score of 65%. In some embodiments, the workspace score icon may be shown in the top right of the workspace page. In other embodiments, the workspace score icon may be in a different location. Optionally, the workspace score may be placed in a desired location or fixed to the task bar by the user and/or system administrator.

FIG. 4C shows an example view of the graphical user interface including the workspace score icon and a workspace score. In some embodiments, when a user hovers a mouse over the workspace icon, it shows the numeric value of the workspace score. For example, in FIG. 4C, the workspace score is 65, to indicate 65% utilization.

FIG. 4D shows an example view of the graphical user interface including a drop down menu providing access to the workspace score. In some embodiments, the user or administrator may find out more about the workspace score by clicking on the workspace icon. Clicking on the workspace icon may result in selectable options such as “account settings”, “about workspace”, “check workspace score” and “logout”. In some cases, these selectable options are displayed as a drop down menu.

FIG. 4E shows an example view of the graphical user interface including dimension details used to calculate the workspace score. In some cases, this view is reachable by selecting the “check workspace score” option.

FIG. 4E may show the details regarding which dimensions led to the workspace score. In some embodiments, the workspace score may be calculated by taking into account the following 4 dimensions: the immersion dimension, the mature dimension, the vendor-preference dimension, and the discovery dimension. Those skilled in the art will recognize that these are not the only dimensions that may be used, but serve as examples of some of the types of dimensions that may be considered in determining a workspace score.

The immersion dimension denotes the degree that the user leverages applications in the remote environment on workspace in comparison with leveraging applications in the local environment. In some embodiments, the immersion dimension calculation only includes the application when the application is provided both in the local environment and in the remote environment workspace. In some embodiments, this is performed by doing a comparison of the applications used and the applications provided in workspace, for instance by forming or comparing to a list of applications in workspace.

In some embodiments, the calculation may include all applications which provide the same function as the application used in the local environment. For example, use of an application in the local environment may be used in the calculation when a different application which provides the same function is available in remote workspace. In the immersion dimension GUI, instructions may be included to help guide the user to take advantage of the applications provided by workspace.

One possible method of calculating this value is shown below:

$${P}_{immersion} = \frac{{Count}_{apps \_ used \_ via \_ Worksapce}}{{Count}_{apps \_ available \_ i n \_ Worksapce}}$$

Pᵢₘₘₑᵣₛᵢₒₙ refers to the proportion of immersion dimension.

The mature dimension denotes how many features have been used by the user when compared with all the features supported by workspace. This dimension guides user to get to know more and become more familiar with the workspace. Pₘₐₜᵤᵣₑ refers to the proportion of mature dimension. In one example embodiment, it can be calculated as shown below:

$${P}_{mature} = \frac{{Count}_{features \_ tried}}{{Count}_{all \_ features \_ available}}$$

The vendor-preference dimension denotes what fraction of the tools the user is utilizing from a preferred vendor. This dimension gives the user an intuitive sense on how he/she can leverage applications provided by a preferred vendor to achieve the same goal for which he/she is depending on other tools. In some embodiments, the user or administrator may select the preferred vendor. This selection may be based on use cost, license agreement, preference, or for any other reason. The vendor-preference dimension denotes the percentage of applications the user is using the preferred vendor for when compared with the overall possible number of applications for which the user may use the preferred vendor. P_{vendor_preference} refers to the proportion of vendor-preference dimension. In one example embodiment, it can be calculated as shown below:

$${P}_{vendor \_ preference} = \frac{{Count}_{used \_ vendor \_ owned \_ apps}}{{Count}_{all \_ available \_ vendor \_ owned \_ apps}}$$

The discovery dimension denotes how many applications have been used by the user compared with all the applications provided in workspace. This dimension guides the user to on how he/she can leverage applications in the workspace. This can benefit future usage on workspace when the user faces new tasks. To contrast with the immersion dimension, the discovery dimension is a more generic dimension that calculate all applications whereas the immersion dimension focuses primarily on the applications used by the user.

In some embodiments, the discovery dimension may focus on a subset of applications depending on the role of the user. For instance, if the user's primary role is that of a writer or an editor, the score calculator may calculate the discovery dimension based on the percent of word processing tools rather than the percent of tools overall. In contrast, if the user's primary role is that of a software engineer, the discovery dimension may be calculate the discovery dimension based on the percent of software development tools used compared with all the software development applications provided in workspace. The users role may be determine from things such as the user profile or determined by the workspace system by the actions or tools used by the user over time.

P_{discovery} refers to the proportion of discovery dimension. In one example embodiment the discovery dimension can be calculated as below:

$${P}_{discovery} = \frac{{Count}_{apps \_ used}}{{Count}_{all \_ apps}}$$

The overall workspace score may be calculated based on all of the dimensions. For instance, the workspace score may be calculated based on the immersion dimension, the mature dimension, the vendor preference dimension, and the discovery dimension. In some embodiments, the workspace score may be the sum of all the dimensions. In other embodiments, the workspace score may be a weighted sum of all the dimensions. The weighting factor may be based upon the overall importance of each factor in the workspace score. This weighting factor may be preset, or may be set based on user interactions. For instance, the weighting factor may be higher for dimensions where more data has been collected. The weighting factor may be updated based on analyzed data across a single user or across multiple users. This weighting factor, sometimes referred to as the dimension or D factor, may sum to 100 across all dimensions.

The workspace score may be calculated based on the score of each dimension. One possible example of how to calculate the workspace score S, is shown below:

S=Pᵢₘₘₑᵣₛᵢₒₙ*Dᵢₘₘₑᵣₛᵢₒₙ*Pₘₐₜᵤᵣₑ*Dₘₐₜᵤᵣₑ+P_{vendor_preference}*D_{vendor_preference}+P_{discovery}*D_{discovery}

The value of Dᵢₘₘₑᵣₛᵢₒₙ+Dₘₐₜᵤᵣₑ+D_{vendor_preference}+D_{discovery} may be confinable. In this example, the dimension or D factor is confinable and sums to 100 across the dimensions.

(Dᵢₘₘₑᵣₛᵢₒₙ+Dₘₐₜᵤᵣₑ+D_{vendor_preference}+D_{discovery}=100)

FIG. 4F shows an example view of the graphical user interface. Shown is a drill down tab view of the Immersion Dimension. The graphical user interface gives an intuitive perspective on how the Immersion Dimension is calculated. For instance, the interface shows the applications used in the workspace as well as the number of overall tools used daily. For each dimension, the graphical user interface may include a tab giving a summary for that specific dimension and suggestions to guide the user into taking better advantage workspace, thus improving the score for that dimension.

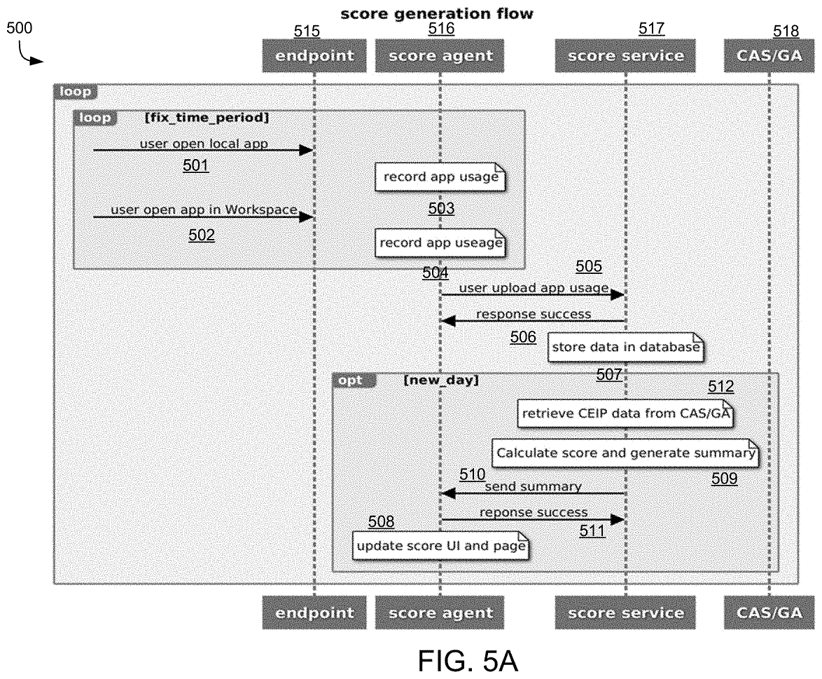

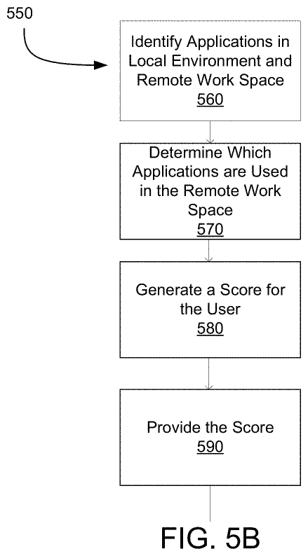

FIG. 5A is a flow diagram of one embodiment of a method of generating and displaying a workspace score. At step 501, a user endpoint device 515 may open a local application. The local applications 406 may be downloaded and run directly from the endpoint device 402. The local application 406 may already be installed on the endpoint device 515 and the user selects the local application to execute or launch the local application.

At step 502, a user endpoint device 515 may open an application in a remote desktop workspace. The endpoint device 515 may directly open an application in a remote desktop workspace or the endpoint device 515 may interact with a local application which relays a request to open a different application from the local application to the same application on a remote desktop workspace. In some embodiments, the user endpoint device 515 nay open an application in workspace using a workspace app 404. The workspace app 404 may be an application that allows other applications to run on a remote desktop. The workspace app 404 may be run on the remote desktop or run on the endpoint device 402. If run on the remote desktop, the workspace app 404 may run additional applications within the workspace application. In some embodiments, the workspace app 404 may direct use of the other applications on the remote desktop.

At step 516, the score agent 517 may record the application usage 503 of applications used locally. For instance, at step 501, a user may open a local application. At step 516 the score agent may record the local application usage at step 503. The workspace scoring system may determine the presence of the same applications on a remote desktop or virtual machine.

At step 516, the score agent may also enter step 504 and record the application usage in workspace. For instance, in step 502, a user may open an application in the workspace. At step 516, the score agent may begin step 504 and record any application usage that occurred in the workspace.

At step 505, the score agent may upload the application usage to the score service 517. The score service 517 may respond to the score agent at step 506 to record successful reception of the application usage.

At step 507, the score service 517 may store the application usage data in a database. In some embodiments, the cloud 410 may include a database 414. The score service 412 may access the database 414 to store one or more of raw data, historical workspace scores, dimensions used for calculations, endpoint device data, or other information related to the workspace score. The score service 412 may utilize the data stored in the database 414 to determine user trends, perform comparative analysis, and optimize the algorithms used to determine the workspace score

At step 512, the score service 517 may retrieve CEIP data from CAS/GA 518. The score agent 409 may determine which applications are provided on both the endpoint device 402 and the remote desktop. In some embodiments, the data may be collected by the score agent 409 by analyzing user information, such as by analyzing Windows Customer Experience Improvement Program (CEIP) data. For the vendor-preference dimension, the score agent may monitor all the vendor-owned applications. In some embodiments, only the vendor-owned applications utilized remotely are monitored. In other embodiments, the remotely accessed vendor-owned applications are monitored in workspace and the locally accessed vendor-owned applications are monitored by analyzing user information, such as the CEIP data.

The score service may query the CEIP data, such as from the Central Authentication Service (CAS) to collect user data, for one or more dimensions. In some embodiments, the score service 412 will wait for data collected from the score agent for one or more dimension. For example, the score service may collect the data for the mature dimension while the score agent collects the data from the remaining dimension and forwards it to the score service. The score service 412 may calculate the workspace score upon request, or at a specified interval (for instance, once a day). The score service 412 may generate a summary based on the workspace score and send it to the score agent 409.

At step 509, the score service 517 may calculate the workspace score and generate a value of the workspace score and/or each of the dimension calculations and factors used for the workspace score. The workspace score may be calculated based on a set of user activity attributes called dimensions. These dimensions may include the immersion dimension, the mature dimension, the vendor preference dimension, and the discovery dimension.

At step 510, the score service 517 may send the summary of the workspace scores such as the overall score and/or dimension scores and factors to the score agent 516. The score agent 516 may indicate response success to the score service 517. In some embodiments, the score agent 516 may query the score service 517 regarding the workspace score and/or dimension calculations and factors. For instance, the score agent 516 may query the score service 517 on a periodic basis such as once a day, once an hour, or once a minute to update the workspace scores. The score agent may store these scores in a database.

At step 508, the score agent 516 may update the score in the UI and/or page to reflect the summary received from the score service 517 at step 510. For instance, the score agent 516 may cause the change of the scores displayed on the GUI. The score agent 516 may automatically make the update when it has received an update to the workspace score. The score agent 516 may periodically update the scores by retrieving the current scores from a data base where the score agent 516 has stored the current scores.

FIG. 5B is a flow diagram 550 of one embodiment of a method of generating and displaying a workspace score. In brief overview, at step 560, the workspace scoring system 400 may identify applications in the local environment and in the workspace. At step 570, the workspace scoring system may determine which applications are being used in the remote workspace. At step 580, the system generate a score for the user. At step 590, the system may provide the user score to the user device

At step 560, the system 400 may identify applications in the local environment and in the remote workspace. For example, the score agent may identify a plurality of applications that are provided both in a local environment of a device and within a workspace accessible via the device. The workspace app and/or score agent may identify via the local operating system which applications are installed or used on the client endpoint. The score agent or workspace app or score service may utilize data logs to identify applications in the local environment. The score service may query the CEIP data, such as from the Central Authentication Service (CAS). The remote workspace may send a list of the applications used in the remote workspace by the user to the client device. The score agent or the score service, may query the remote workspace to determine the applications used in the remote workspace. The list of applications used in the local environment may be compared to the list of applications used in the remote workspace to determine which applications are available in both the local environment and the remote workspace.

The system may send the remote workspace a list of applications used in the remote environment not available on the user device. The remote workspace may store in a database information regarding applications used in the local environment which are not available in the remote workspace. This data may be aggregated across multiple users and used to determine additional applications to make available in the remote environment.

At step 570, the system may determine which applications are being used in the remote workspace. For example, the score agent may determine which one or more of the plurality of applications are used by a user of the device via the workspace instead of the local environment of the device. The score agent or workspace app may monitor which one or more applications in the local environment the device are opened by the user. In some embodiments, the system may analyze the applications used in the remote environment which are also available in the local environment. In other environments, all applications used in the remote environment may be analyzed regardless of their availability in the local environment. The remote workspace may track the frequency and time each application is used. The remote workspace may send a list of the applications used in the remote workspace by the user to the client device, such as to workspace app or score agent. The system such as via score agent determined a number of features the user accessed in the workspace in comparison to a predetermined number of features provided by the workspace. The system such as via score agent determining a number of applications of a specific vendor the user accessed in the workspace in comparison to a total number of applications provided by the specific vendor in the workspace

At step 580, the system may generate a score for the user, such as using any of the embodiments of calculating a score described in connection with FIG. 4E. The score agent may cause generation of a score for the user, by for example sending data, such as from monitoring, to the scoring service. The score identifying a degree of which the user makes use of the workspace. The score agent may receive the workspace score calculated by the scoring service. The score agent may calculate the workspace score.

The score may be generated based on a set of user activity attributes or features, such as any of those features referred to as dimensions described in connection with FIG. 4E. These factors may include those that are influenced by the degree the user leverages the remote workspace environment. For instance, a factor may be how many features in workspace have been used by the user when compared with all the features supported by workspace. Another factor may be what fraction of applications in workspace a user is utilizing from a preferred vendor. Another factor may be how many applications the user has used in workspace compared with all the applications provided in workspace. Other factors indicating the degree to which the user is utilizing the remote workspace over the local environment may be included. These factors may be used, combined or provided as input to a function to generate an overall workspace score.

The score may be generated based at least on the number of features, such as the number of features the user accessed in the workspace in comparison to a predetermined number of features provided by the workspace. The score may be generated based on a number of applications the user accessed in the workspace in comparison to a predetermined number of applications provided by the workspace. The score is generated based at least on the number of applications. The score may be generated based on a number of applications of a specific vendor the user accessed in the workspace in comparison to a total number of applications provided by the specific vendor in the workspace

At step 590, the system may provide the user's workspace score to a user's device such as the endpoint device, for example to be displayed on a user interface of the workspace app. The user's score may include the overall workspace score and/or the score for individual factors or dimensions making up the workspace score. The user score may be stored in a database and may be used to update the GUI. The GUI may be updated responsive to the user device receiving a new score, or may be updated at a periodic interval (e.g., every minute, hour, day, etc.) with the current score saved in the database. The GUI may be updated responsive to interaction with the user interface by the user, such as a selection or launching of an application or selecting a refresh button. The system may replace the score, or may store all historical scores. Historical scores may be graphed for the user to show improvement in the workspace score. Other graphical comparatives for historical scores may be shown to the user in order to increase gamification.

Various elements, which are described herein in the context of one or more embodiments, may be provided separately or in any suitable sub combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
identifying, by a score agent, a plurality of applications that are provided both in a local environment of a device and within a workspace accessible via the device;
determining, by the score agent, which one or more of the plurality of applications are used by a user of the device via the workspace instead of the local environment of the device;
causing, by the score agent, generation of a score for the user, the score identifying a degree of which the user makes use of the workspace; and
providing, by the score agent, the score for display in the workspace.

2. The method of claim 1, further comprising monitoring, by the score agent, which one or more applications in the local environment the device are opened by the user.

3. The method of claim 1, further comprising determining, by the score agent, a number of features the user accessed in the workspace in comparison to a predetermined number of features provided by the workspace.

4. The method of claim 3, wherein the score is generated based at least on the number of features.

5. The method of claim 1, further comprising determining, by the score agent, a number of applications the user accessed in the workspace in comparison to a predetermined number of applications provided by the workspace.

6. The method of claim 5, wherein the score is generated based at least on the number of applications.

7. The method of claim 1, further comprising determining, by the score agent, a number of applications of a specific vendor the user accessed in the workspace in comparison to a total number of applications provided by the specific vendor in the workspace.

8. The method of claim 7, wherein the score is generated based at least on the number of applications.

9. A system comprising:
one or more processors, coupled to memory, to:
identify a plurality of applications that are provided both in a local environment of a device and within a workspace accessible via the device;
determine which one or more of the plurality of applications are used by a user of the device via the workspace instead of the local environment of the device;
cause generation of a score for the user the score identifying a degree of which the user makes use of the workspace; and
provide the score for display in the workspace.

10. The system of claim 9, wherein the one or more processors are further configured to monitor which one or more applications in the local environment the device are opened by the user.

11. The system of claim 9, wherein the one or more processors are further configured to determine a number of features the user accessed in the workspace in comparison to a predetermined number of features provided by the workspace.

12. The system of claim 11, wherein the score is generated based at least on the number of features.

13. The system of claim 9, wherein the one or more processors are further configured to determine a number of applications the user accessed in the workspace in comparison to a predetermined number of applications provided by the workspace.

14. The system of claim 13, wherein the score is generated based at least on the number of applications.

15. The system of claim 9, wherein the one or more processors are further configured to determine a number of applications of a specific vendor the user accessed in the workspace in comparison to a total number of applications provided by the specific vendor in the workspace.

16. The system of claim 15, wherein the score is generated based at least on the number of applications.

17. A non-transitory computer readable medium storing program instructions for causing one or more processors to:
identify a plurality of applications that are provided both in a local environment of a device and within a workspace accessible via the device;
determine which one or more of the plurality of applications are used by a user of the device via the workspace instead of the local environment of the device;
cause generation of a score for the user the score identifying a degree of which the user makes use of the workspace; and
provide the score for display in the workspace.

18. The non-transitory computer readable medium of claim 17, wherein the program instructions further cause the one or more processors to monitor which one or more applications in the local environment the device are opened by the user.

19. The non-transitory computer readable medium of claim 17, wherein the program instructions further cause the one or more processors to determine a number of features the user accessed in the workspace in comparison to a predetermined number of features provided by the workspace.

20. The non-transitory computer readable medium of claim 19, wherein the score is generated based at least on the number of features.
